(19) United States
(12) Patent Application Publication
(10) Pub. No.: US 2014/0157333 A1
(43) Pub. Date: Jun. 5, 2014

(54) SYSTEM AND METHOD FOR PROVIDING CUSTOMIZED CONTENT AND ENTERTAINMENT TO CUSTOMERS OF A VENUE

(71) Applicants: ISAAC S. DANIEL, Miramar, FL (US); WEUSI ERSKINE, Miramar, FL (US); ALBERTO INTERIAN, III, Miramar, FL (US)

(72) Inventors: ISAAC S. DANIEL, Miramar, FL (US); WEUSI ERSKINE, Miramar, FL (US); ALBERTO INTERIAN, III, Miramar, FL (US)

(21) Appl. No.: 13/925,622

(22) Filed: Jun. 24, 2013

Related U.S. Application Data
(60) Provisional application No. 61/663,424, filed on Jun. 22, 2012.

(51) Int. Cl. H04N 21/414; H04N 21/214

(52) U.S. Cl. CPC H04N 21/41407; H04N 21/214
USPC 725/81

(57) ABSTRACT

A system for providing content and entertainment to customers of a venue that includes at least one processor and computer executable instructions readable by the at least one processor and configured to receive audio or video content from at least one media device positioned in at least one venue, transmit the audio or video content to at least one mobile device, and transmit at least one custom graphical user interface or information related to the at least one custom graphical user interface to the at least one mobile device.

### PRIORITY CLAIM

The present application is a non-provisional patent application based on U.S. provisional patent application Ser. No. 61/663,424, titled “System and Method for Providing Content and Entertainment to Customers of a venue” filed on Jun. 22, 2012. The entire disclosure of the afore-mentioned patent application is incorporated by reference as if fully stated herein.

### FIELD

The present disclosure relates generally to electronic systems and methods, and more particularly, to electronic systems and method for transmitting content to customer mobile devices.

### BACKGROUND

Entertainment, such as television entertainment, including sports, movies, news, and the like, is often provided to customers of venues, such as restaurants, bars, airports, gyms, doctor offices, and the like. In some cases, venues will feature more than one program on a plurality of televisions. More often than not, the volume on the televisions showing the content is either muted (as in the case of bars and restaurants), or tuned only to one program, so that the other programs cannot be heard.

Up until now, venues have attempted to solve this problem by broadcasting the audio from the television sets by using short range FM broadcasters. This has proven ineffective, as customers do not usually carry FM receivers with them, and FM broadcasts are susceptible to interference. Furthermore, FM broadcasting must be pre-approved by the Federal Communications Commission, which complicates the deployment of FM based systems.

Other similar systems exist as well, such as the Sports Select™ system (see http://www.seeoursound.com) and the Soundog™ system (see http://www.mysoundog.com), which comprise of a FM broadcaster that broadcasts the audio signals from the televisions to a table-top FM receiver, whereby customers can plug their headsets into the table top receivers to listen to the television programming. This type of system also has its downsides, since it requires each and every table to be equipped with a receiver, which can be damaged by spills, can be stolen, and adds additional equipment costs and maintenance. Furthermore, it requires that headphone cables be strewn all over dining tables, since everyone seated at a table will have their headphones plugged into a single receiver. The cables can interfere with dining, and even cause spills.

Furthermore both of the aforementioned systems provide for only one-way communication with customers, namely the transmission of audio, and customer feedback and input cannot be solicited.

### SUMMARY

The various embodiments of systems and methods disclosed herein result from the realization that venue based content-over-air systems may be made more convenient, user friendly, and legally compliant by providing a system that provide custom graphical user interfaces to mobile devices based on the mobile devices' locations or venues, and providing various geo-fencing systems and methods to ensure content is broadcasted only to those users who are authorized to receive the content.

### BRIEF DESCRIPTION OF THE DRAWINGS

FIG. 1A shows a system in accordance with one embodiment;

FIG. 1B shows a signal processor in accordance with one embodiment;

FIG. 1C shows a mobile device in accordance with one embodiment;

FIG. 2A shows a system in accordance with another embodiment;

FIG. 2B shows a mobile device in accordance with another embodiment;

FIG. 3A shows a system in accordance with yet another embodiment;

FIG. 3B shows a mobile device in accordance with yet another embodiment;

FIG. 4 shows a block diagram representing a method in accordance with one embodiment; and

FIG. 5 shows a block diagram representing an article in accordance with one embodiment.

### DETAILED DESCRIPTION OF PREFERRED EMBODIMENTS

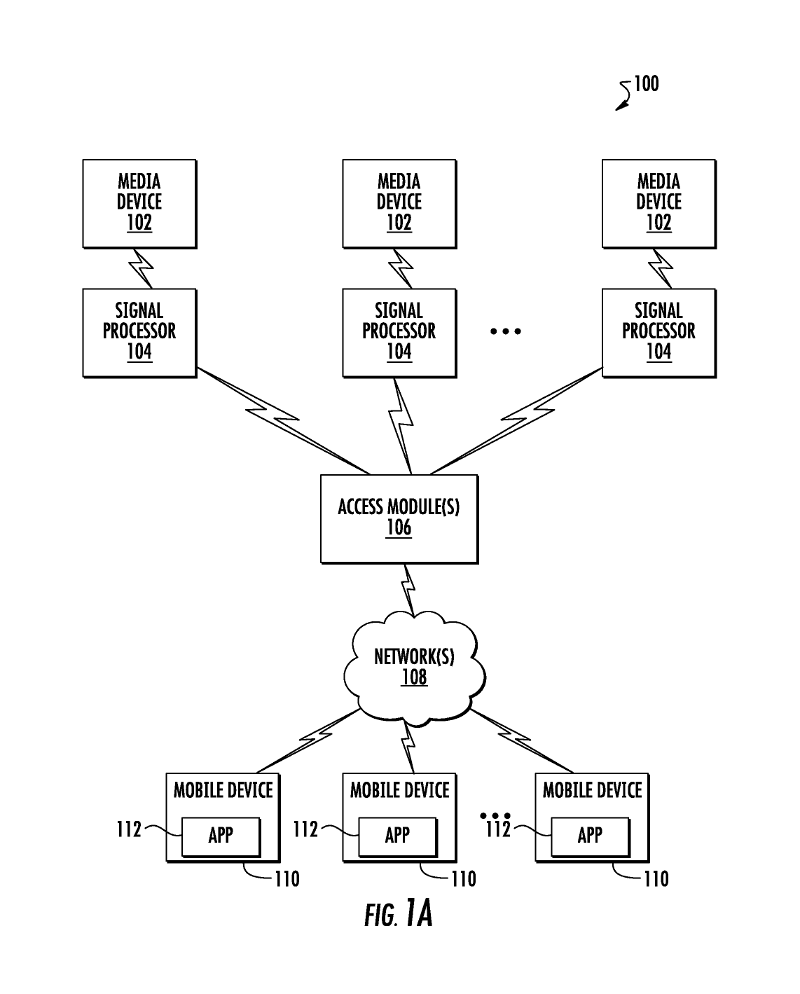

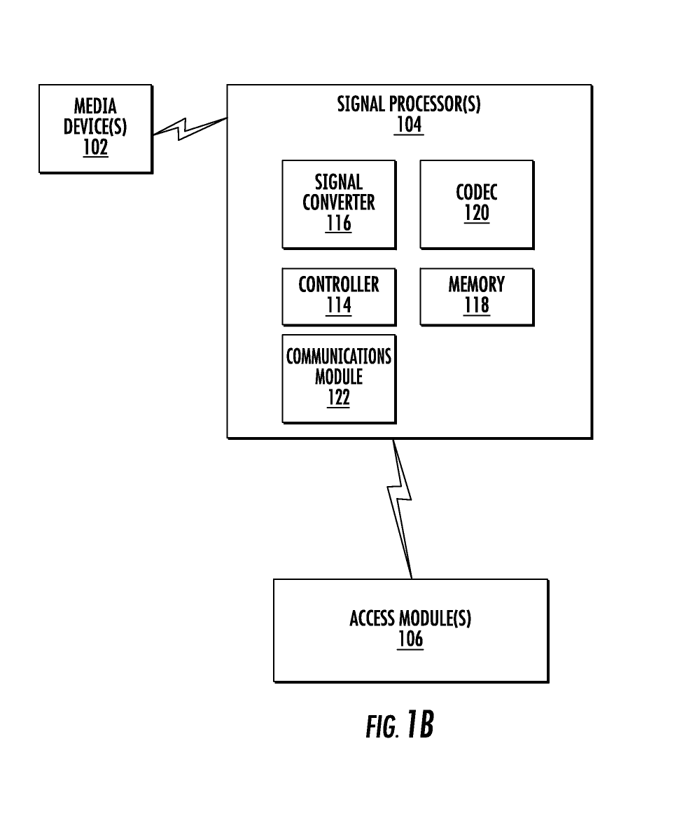

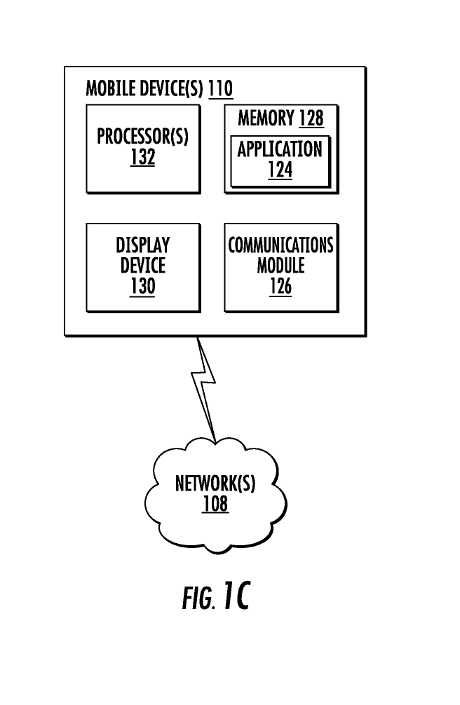

Referring now to FIG. 1A a system 100 for providing content to customers is shown, wherein system 100 comprises one or more media devices 102 having an audio output, one or more signal processors 104 connected to the audio output and configured to capture and transmit (or broadcast) audio (or video) being played by the media device 102, a wireless local area network (“WLAN”) access module(s) or access point(s) 106 connected to the signal processor 104 and configured to establish a wireless local area network(s) 108, and one or more mobile devices 110 running an application 112, wherein the mobile device 110 is configured to connect to the signal processor 104 via the WLAN 108 and use the application to receive and play the audio being broadcasted by the signal processor 104.

The term “content,” as used herein, may comprise any type of content, such as, but not limited to, audio or video content, which may include sports content, television content, news content, movie content, music content, and the like.

In some embodiments, the media device 102 may be any type of media device, such as, but not limited to, a set top box, such as, but not limited to, a cable television box, a satellite television box, a internet protocol television (“IPTV”) set to box, a media PC, a smart TV box, a smart TV, a DVD player, a Blu Ray player, a FM radio, tape player, or any other audio source. In another embodiment, the media device 102 may be a television having an audio output. In general, the media device 102 may be any type of device capable of receiving media from a media provider and playing the media. The audio output may be either an analog audio output or a digital audio output. It should be noted that for simplicity, the embodiments described herein refer to an audio output, however the various systems and methods disclosed herein may be used in conjunction with audio and/or video outputs and may be used to broadcast audio and/or video content. The audio output may comprise an audio output port, such as an analog audio output port, such as an RCA port, a 3.5 mm jack, and the like. In another embodiment, the audio output may comprise a digital output port, such as an HDMI port, S/PDIF, an optical port, and the like.

In some embodiments the signal processor 104 may comprise an audio input port. The signal processor 104 may be connected to the media device 102 via a cable. The signal processor may be positioned near the media device 102, such as on top of it or behind it, or the signal processor 104 may be positioned away from the media device 102, such as in a component rack or closet. In some embodiments, the signal processor 104 may be capable of connecting to a plurality of media devices 102, and capturing and broadcasting the audio from the plurality of media devices 102. In some embodiments, a plurality of signal processors 104 may be contained in a single enclosure, which may include a plurality of signal processors 104 sharing a motherboard.

In a further embodiment, shown in FIG. 1B, the signal processor 104 may comprise a microcontroller 114, a signal converter 116 for converting an analog signal to digital signal, a memory module 118 for caching the data contained in the audio signal, an audio encoder (or codec) 120 for encoding the audio signal, and a communications module 122 for transmitting the audio signal, wherein the communications module 122 may comprise an Ethernet controller. In some embodiments, the signal processor 104 may be connected to the WLAN access module via an Ethernet cable.

The signal processor 104 may be configured to capture the audio from the media device 102, convert the audio if necessary (from analog to digital), encode the audio into any type of format, such as MPEG, pulse-code modulation (“PCM”), and the like, and transmit/broadcast the audio via internet protocol (“IP”). Accordingly, each signal processor 104 or each audio broadcast may be associated with a particular IP address. The IP address may be accessed only via the WLAN. In some embodiments, the signal processor 104 and the mobile device 110 may be connected using real-time transport protocol (“RTP”).

In some embodiments, the signal processor 104 may be connected to a remote server (not shown), which may provide additional content to be provided to the mobile devices, such as advertising, music, custom graphical user interfaces, and the like.

In some embodiments, the WLAN access module 106 may comprise a router connected to wireless access point. In other embodiments, the WLAN access module may comprise a WLAN router, which may comprise an access point and router integrated into a single unit. The WLAN access module 106 may comprise a plurality of antennas positioned throughout a venue, such as a restaurant, bar, airport, hotel, hospital, and the like. In another embodiment, the system may comprise a plurality of WLAN access modules 106, wherein said plurality of WLAN access modules 106 may be positioned throughout a venue. In yet another embodiment, the WLAN access module 106 may comprise a plurality of routers, a plurality of WAPs, and a plurality of antennas. In yet another embodiment, the WLAN access module 106 may comprise at least one router connected to at least one WAP, wherein the WAP comprises at least one antenna. The WLAN access module 106 may be configured to establish a WLAN, to which the mobile devices 110 may connect.

In some embodiments, the mobile device 110 may comprise any type of mobile device, such as a cellphone, a tablet PC, a handheld PC, a smartphone, a PC, a laptop, or any other type of electronic device capable of connecting to the WLAN and accessing the audio broadcast. Accordingly, as shown in FIG. 1C, the mobile device 110 may comprise audio play back software, such as a mobile application 124, a communications module 126 configured to connect to the WLAN 108, memory 128, a display device 130, a processor 132, and the like.

In some embodiments, the application 124 may comprise a set of computer executable instructions that are stored on the memory 128 of the mobile device 110. In another embodiment, the application 124 may comprise a set of computer executable instructions that are stored on a server and accessed by the mobile device 110.

The application 124 may be configured to connect to the signal processor 104 via the WLAN 106 and WLAN access module 106, receive or access the audio broadcast, decode the audio signal, and play the audio content via an audio playing means on the mobile device 110 (e.g. speaker or headphones). In some embodiments, the application 124 may be configured to present a graphical user interface (GUI) on the mobile device 110, wherein user input may be solicited and content may be displayed, wherein content may be any type of content, such as advertising, content being played by the media device 102, content received from a server, sports content, news content, television content, user generated content, and the like.

In some embodiments, the application 124 may be configured present an option to choose which WLAN 108 to connect to. In other embodiments, the application 124 may be configured to automatically connect to the WLAN 108.

Once connected to the WLAN 108, the application 124 may be configured to present a user with options to choose which media device 102 audio stream to connect to. For example, a game may be shown on one TV(s), such as TV 1, while news may be shown on another TV(s), such as TV 2. The user may be able select which media device 102 or channel to connect to. The mobile application 110 may be configured to allow users to switch back and forth between media devices/audio channels. In some embodiments, the media devices 102 (such as TVs) may be labeled with numbers or identifiers, so that users can see the number of the TV and then select a corresponding menu option in the application 124.

In yet another embodiment, the system 100 may be configured to use the signal processor 104 to capture an image(s) being presented on the media device(s), and push the image(s) to the application 124 (e.g. to populate menu options with images of the content being played by the respective media devices) so that the user can see which media devices 102 are playing which content, and then select the audio broadcast stream that corresponds to a particular media device 102 and captured image. In some embodiments, the image may be received from a remote server, wherein said remote server may be connected to the signal processor 104 via a wide area network, such as the internet.

In yet another embodiment, the application 124 may be configured to present advertisements to a user, wherein said advertisements may be for products/services available at the venue that they are in. In yet another embodiment, the advertisements may be for products/services outside of the venue or near the venue. The application 124 may be configured to determine a location of the mobile device 110 by using a location determination device, such as the mobile device 110's GPS module, or by calculating the location based on WLAN positioning, IP address, or cellular phone tower triangulation. In yet another embodiment, if a product or service is being advertised in the content being played by the media device 102, or in an another advertisement being presented on the mobile application 124, the user may be presented with the option to purchase said advertised product or service using their mobile device 110. In yet another embodiment, if a product or service that is advertised in the content being played by the media device 102, or another advertisement being presented on the mobile application 124, and said product or service is available for purchase at the venue, the user may be presented with the option to purchase said advertised product or service, and once purchased, the venue may be notified that the user has purchased said advertised product or service so that an employee of the venue may bring the user the purchased product or service.

In yet another embodiment, the application 124 may be configured to present the user with a menu, such as a restaurant and bar menu, and may be configured to allow users to order items on the menu via the application 124. Accordingly, the system 100 may feature an order processing module whereby orders placed using the app may be presented to waiters. The order processing module may be connected to the WLAN 108 as well. The application 124 may be configured to allow users to call for help, whether it be a waiter, a nurse, and the like, depending on where the system 100 is deployed.

In yet another embodiment, the application 124 may feature a social media feature, wherein users at a location may be able to interact such as by posting status updates, via user profiles, by sending messages to each other, and by ordering menu items for each other. In yet another embodiment, the application 124 may be configured to allow users to pay for purchased products or services (e.g. menu items) via their mobile device 124. In another embodiment, the application 124 may be configured to interface with a third party social network, such as Facebook™, Twitter™, LinkedIn™, or JustSync™, and social media updates/messages may be shared between the application 124 and said third party social networks. The application 124 may further be configured to allow users to post their locations, as well as messages photos, and videos along with the location. In yet another embodiment, the application 124 may feature a dating feature, such as online dating, social network dating, location based dating, and the like, wherein users may be able to engage in flirtation or dating related interactions with other users (in the venue or outside the venue), such as private messages, e-winks, pokes, and other communications, as well as allowing users to purchase products or services for other users via the application 124, such as drinks or food. In yet another embodiment, the application 124 may be configured to allow users to communicate with each other using voice communication, video communication, teleconferencing, group communication, and the like.

In another embodiment, the application 124 may be configured to present users with advertising when the television goes to programming, and, more specifically, the application 124 may be configured to usurp advertising that is being played by the media device 102 with advertising that is provided via the signal processor 104, wherein said advertising may be custom advertising for the venue or other providers.

In one embodiment, the application 124 may be configured to present a skin or theme in the GUI based on the venue. The skin or theme may be determined by identifying which WLAN access module 106 the mobile device 110 is connected to, or by location determination methods and devices, as described above.

In yet another embodiment, the application 124 may be configured to create a geo-fence, such as by using a GPS or WLAN positioning system module in the mobile device 110, or by other location determination means (as described above), wherein if a user goes out of the geofence, they will no longer be authorized to access the audio broadcast via the WLAN 108. The geofencing function may also be accomplished by limiting access to the audio broadcast to those mobile devices 110 running the application 124 and connected to the WLAN 108. Thus, users will not be able to receive the audio broadcast unless they are connected to the WLAN 108, and the WLAN 108's coverage may be limited to the venues that are playing the content whose audio is being broadcasted by the system 100. In some jurisdictions, re-broadcasting content to users may comprise copyright violation, unless said users are authorized to receive, view, or hear said content. In most cases, patrons of a venue are authorized to receive, view, and heard content being played at the venue. By geo-fencing users to locations where they are authorized to receive, view, or hear the content, the systems and methods described herein may be operated and performed in a legal manner and without violating copyright law.

In yet another embodiment, the application 124 may be configured to allow important alerts or messages to be transmitted to mobile devices 110, wherein emergencies may be announced (such as a fire and the like), or special deals at the venue may be announced.

In another embodiment, the application 124 may allow users to play games, such as trivia games, video games, and the like. The games may be played for prizes offered by the venue (e.g. food or drink items), or for other prizes (e.g. cash, products, services). The games may be played by users against other users in the venue, such as in the case of trivia and the like. In yet another embodiment, users may play against users in other venues in other locations. For example, if a sports game is being played by two teams in two respective cities, and the sports game is being broadcasted in venues in those cities, users in one city may be able to play the games in the application 124 against users in the other city. In one embodiment, the games may be related to the content being broadcasted at the venue, such as a trivia game related to a sports game, fantasy sports game, gambling game, and the like.

In yet another embodiment, the application 124 may be configured to prompt a user for a password to access the WLAN 108, the audio broadcast, or both. The password may be provided by the venue to the user.

In yet another embodiment, the application 124 may be downloaded by user by providing user with a hyperlink to download the application 124. The application 124 may be provided via an online application store, such as Google Play™, Apple App Store™, via a website, or locally, via the WLAN 108. In yet another embodiment the system 108 may comprise a physical object positioned in or near the venue, wherein the physical object may have a link on it, and wherein the physical object may comprise, but is not limited to, placards, posters, stickers, table tents, table cards, menus, window stickers, and the like, and may be presented in or near the venues with links to download the application. The link may comprise a scannable code, such as a quick-read code (“QR code”), which may be scanned by the mobile device 110 (using a camera on the mobile device 110) and used to download the application 124.

In yet another embodiment, if a user opens the application 124 and the WLAN 108 is not available, the application 124 may be configured to determine a location of the mobile device 110 (using the location determination means described herein), and present the user with information regarding the locations of available WLAN(s) 108 (or venue with the nearest WLAN 108 or system 100), which may include the nearest WLAN 108. In a further embodiment, the application 124 may be configured to present the user with directions on how to get to the WLAN 108, or venue with the WLAN 108 or system 100, wherein said directions may comprise a map, written directions, step-by-step directions, and the like.

In yet a further embodiment, the application 124 may be configured to present a user with a list or map of venues where the system 100 (including the WLAN 108) is available.

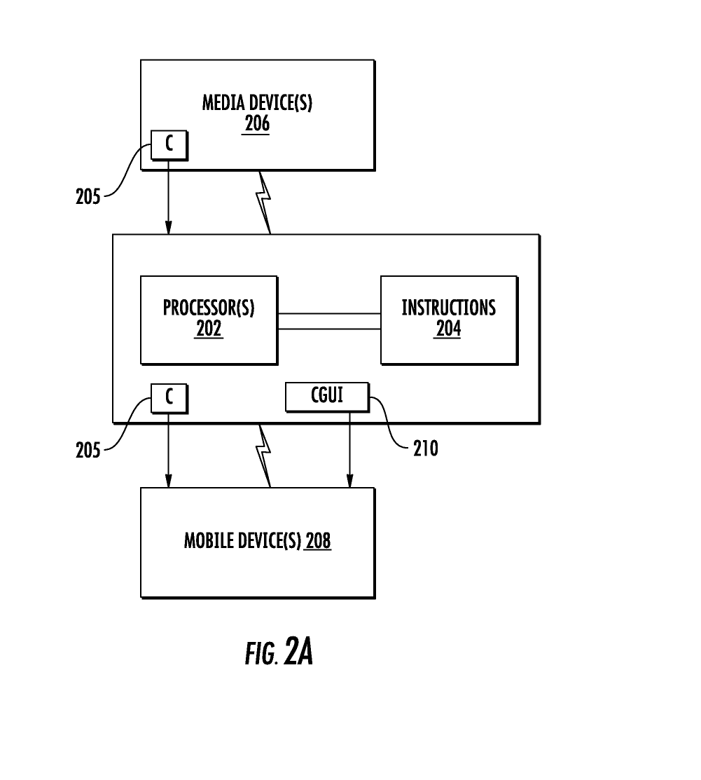

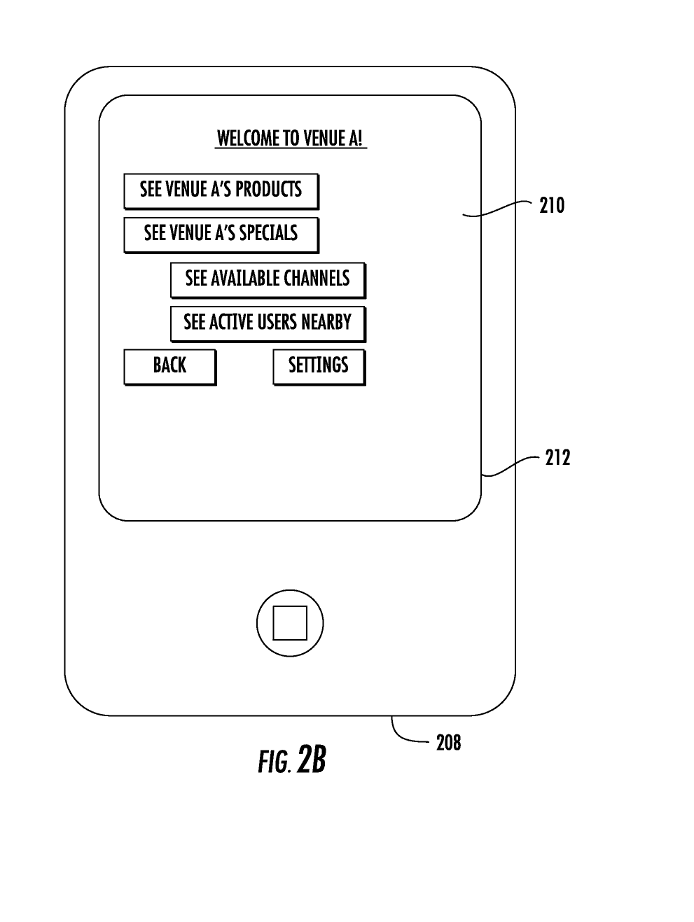

Referring now to FIG. 2A, a system 200 is shown in accordance with one embodiment, wherein system 200 may comprise at least one processor 202 and computer executable instructions 204 readable by processor 202 and configured to receive audio or video content 205 (“content”) from at least one media device 206 positioned in at least one venue, transmit content 205 to at least one mobile device 208, and transmit at least one custom graphical user interface 210 (“CGUI”) or information related to CGUI 210 to mobile device 208.

In some embodiments, processor 202 may comprise any type of processor, such as, but not limited to, a single core processor, a multi core processor, a server processor, and the like. In some embodiments, processor 202 may be connected to, part of, or integrated with at least one content rebroadcasting device. The content rebroadcasting device may comprise a signal processor, such as signal processor 104, described above with reference to FIGS. 1A-1C.

In some embodiments, computer executable instructions 204 may comprise any type of computer executable instructions, such as a computer application, which may be encoded in any computer language. Computer executable instructions 204 may be stored on a transitory or non-transitory computer readable medium, such as a memory module, a hard drive, flash memory, a removable computer readable medium, and the like, wherein said computer readable medium may be connected to or in communication with processor 202.

In some embodiments, at least one media device 206 may comprise any type of media device, such as media device 102, described above with reference to FIGS. 1A-1C.

In some embodiments, content 205 may comprise any type of content, such as those embodiments described herein.

In some embodiments, the at least one venue may be any type of venue or establishment, such as those embodiments described herein.

In some embodiments, at least one mobile device 208 may comprise any type of mobile device, such as mobile device 110 described above with reference to FIGS. 1A-1C.

Accordingly, in some embodiments, mobile device 208 may be connected to processor 202 via a WLAN and a WLAN access module, such as network 108 and access module 106, described above with reference to FIGS. 1A-1C.

In some embodiments, CGUI 210 may comprise any type of graphical user interface, such as those embodiments described throughout the present disclosure. Referring to FIG. 2B, an embodiment of CGUI 210 is shown displayed on a display device 212 of mobile device 208, wherein CGUI 210 may comprise a theme based on the at least one venue. In some embodiments, CGUI 210 may comprise colors, graphics, images, logos, trademarks, designs, and the like associated with the venue. In other embodiment, CGUI 210 may comprise options for viewing venue's products or services, venue's specials, available content 205, social networking features, settings, and the like. CGUI 210 may comprise virtual buttons and entry fields.

In another embodiment, CGUI 210 may comprise information related to content 205, such as available content channels, programming, scheduled times of play, time left in program, screen shots of content 205 (as described above), and the like.

In some embodiments, computer executable instructions 204 may be configured to determine a location of mobile device 208 or receive location related information from mobile device 208. Determining a location of mobile device 208 may comprise using mobile device 208's internet protocol (IP) address to determine the location of mobile device 208, using WLAN positioning techniques to determine the location of mobile device 208, using a location determination device connected to or integrated with mobile device 208 to determine the location of mobile device 208's location, determining which WLAN access module mobile device 208 is connected to, signal triangulation, and other location determination means and methods described throughout the present application. In some embodiments, receiving location related information from mobile device 208 may comprise receiving a location determined by using a location determination device connected to mobile device 208, receiving an IP address, and the like. In some embodiments, computer executable instructions 204 may be configured to determine a location of mobile device 208 based on the location related information.

In some embodiments, computer executable instructions 204 may be configured to determine which venue mobile device 208 is located at, wherein the determination may be based on the location of mobile device 208.

In another embodiment, CGUI 210 may be based on the location of mobile device 208. Accordingly, CGUI 210 may be selected based on the location of mobile device 208. For example, if mobile device 208 is determined to be in Venue A (or a location associated with Venue A), then a CGUI associated with Venue A may be presented to and/or on mobile device 208. If mobile device 208 later moves to Venue B, then a CGUI associated with Venue B may be presented and/or on mobile device 208.

In some embodiments, computer executable instructions may be configured to set up a geofencing rights management system, wherein content 205 may be transmitted to mobile device 208 only if mobile device 208 is located in the venue where content 205 is being played. The computer executable instructions may be operative to track the location of mobile device 208 and if mobile device 208 travels outside of the venue, then the computer executable instructions may be configured to cease transmitting content 205 to mobile device 208.

In some embodiments, transmitting information related to the at least one custom graphical user interface comprises a location of system 100, a location of the mobile device, a location of the venue, a venue identifier, and the like, so that the mobile device can select which CGUI to present.

In some embodiments, computer executable instructions 204 may be operative to receive CGUI 210 from a server, such as a remote server. CGUI 210 may be received via a wide area network, such as the internet. CGUI 210 may be stored in a computer readable medium connected to processor 202.

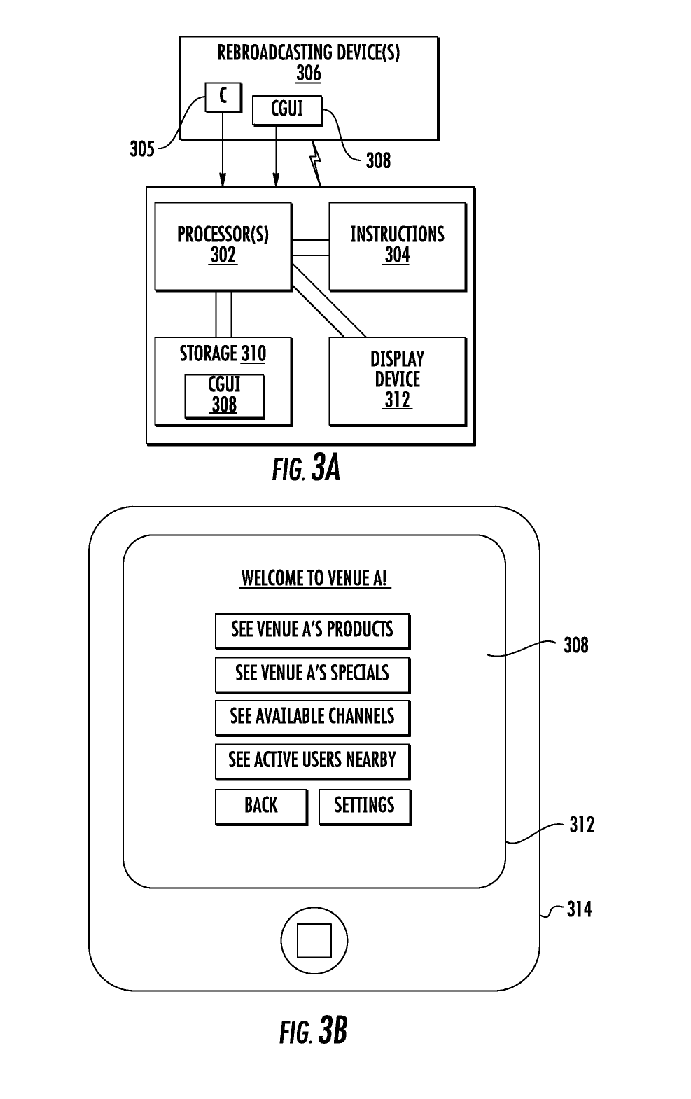

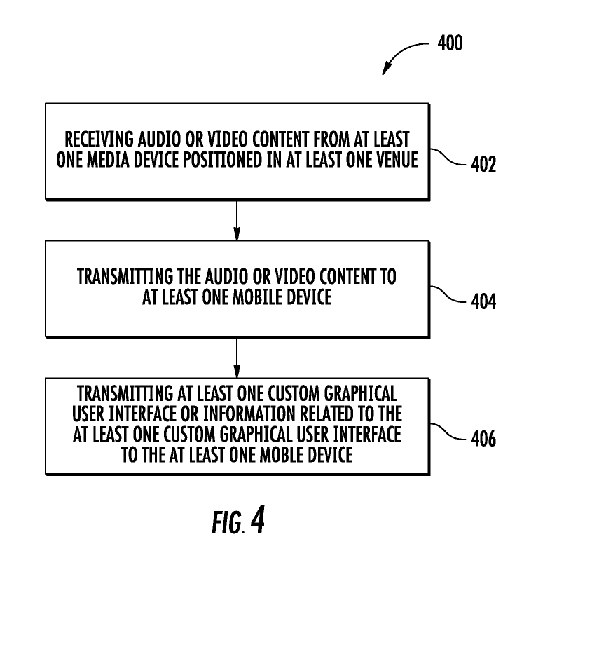

Referring now to FIG. 3, a system 300 is shown in accordance with one embodiment, wherein system 300 may comprise at least one processor 302 and computer executable instructions 304 readable by processor 302 and configured to receive audio or video content 305 (“content”) from at least one content rebroadcasting device 306 positioned in at least one venue, receive at least one custom graphical user interface (“CGUI”) 308 from the at least one content rebroadcasting device 306, or select at least one CGUI 308 stored on a storage module 310 connected to processor 302, and display the CGUI 308 on a display device 312 connected to processor 302.

In some embodiments, processor 302 may comprise any type of processor, such as, but not limited to, a single core processor, a multi core processor, a server processor, and the like. In some embodiments, processor 302 may be connected to, part of, or integrated with at least one mobile device. The mobile device may comprise any type of mobile device, such mobile devices 110, 208, described above with reference to FIGS. 1A-2B.

In some embodiments, computer executable instructions 304 may comprise any type of computer executable instructions, such as a computer application, which may be encoded in any computer language. Computer executable instructions 304 may be stored on a transitory or non-transitory computer readable medium, such as a memory module, a hard drive, flash memory, a removable computer readable medium, and the like, wherein said computer readable medium may be connected to or in communication with processor 302. In some embodiments, computer executable instructions 302 may comprise a mobile application, such as, but not limited to, a downloadable mobile application.

In some embodiments, at least one content rebroadcasting device 306 may comprise any type of content rebroadcasting device, such as signal processor 104, described above with reference to FIGS. 1A-1C, and at least one processor 202 described above with reference to FIGS. 2A and 2B.

In some embodiments, content 305 may comprise any type of content, such as those embodiments described herein.

In some embodiments, the at least one venue may be any type of venue or establishment, such as those embodiments described herein.

Accordingly, in some embodiments, processor 302 may be connected to rebroadcasting device 306 via a WLAN and a WLAN access module, such as network 108 and access module 106, described above with reference to FIGS. 1A-1C.

In some embodiments, CGUI 308 may comprise any type of graphical user interface, such as those embodiments described throughout the present disclosure. Referring to FIG. 3B, an embodiment of CGUI 308 is shown displayed on display device 312 of a mobile device 314, wherein CGUI 308 may comprise a theme based on the at least one venue. In some embodiments, CGUI 308 may comprise colors, graphics, images, logos, trademarks, designs, and the like associated with the venue. In other embodiment, CGUI 308 may comprise options for viewing venue's products or services, venue's specials, available content 305, social networking features, settings, and the like. CGUI 308 may comprise virtual buttons and entry fields.

In another embodiment, CGUI 308 may comprise information related to content 305, such as available content channels, programming, scheduled times of play, time left in program, screen shots of content 305 (as described above), and the like.

In some embodiments, computer executable instructions 304 may be configured to determine a location of processor 302. In another embodiment computer executable instructions 304 may be configured to transmit location related information (or the location) to rebroadcasting device 306. Determining a location of processor 302 may comprise using processor 302's internet protocol (IP) address to determine the location of processor 302, using WLAN positioning techniques to determine the location of processor 302, using a location determination device connected to with processor 302 to determine the location of processor 302's location or a location of the location determination device, determining which WLAN access module processor 302 is connected to, signal triangulation, and other location determination means and methods described throughout the present application. In some embodiments, transmitting location related information to rebroadcasting device 306 may comprise transmitting a location determined by using a location determination device connected to processor 302, determining a location based on an IP address, and the like. In some embodiments, computer executable instructions 304 may be configured to determine a location of processor 302 based on location related information received from rebroadcasting device 306, such as, but not limited to, a location of the venue, WLAN information, WLAN access module information, and the like.

In some embodiments, computer executable instructions 304 may be configured to determine which venue processor 302 is located at, wherein the determination may be based on the location of processor 302.

In another embodiment, CGUI 312 may be based on the location of processor 302 (or a location determination device connected to processor 302). Accordingly, CGUI 312 may be selected based on the location of processor 302. For example, if processor 302 is determined to be in Venue A (or a location associated with Venue A), then a CGUI associated with Venue A may be presented to and/or on display device 312 connected to processor 302. If processor 302 later moves to Venue B, then a CGUI associated with Venue B may be presented and/or on display device 312 connected to processor 302.

There may be a plurality of CGUIs stored on storage module 310, from which a CGUI associated with a current venue may be selected. In some embodiments, the CGUI may be selected based on a location of processor 302, a location of a location determination device connected to processor 302, or the venue.

In a further embodiment, computer executable instructions 304 may be configured to use at least one audio or video broadcasting device connected to processor 302 to broadcast content 305, wherein the audio or video broadcasting device may comprise display device 312, speakers, or audio headphones connected to processor 302.

In some embodiments, computer executable instructions may be configured to set up a geofencing rights management system, wherein content 305 may be played or received only if processor 302 is located in the venue where content 305 is being played. The computer executable instructions may be operative to track the location of processor 302 and if processor 302 travels outside of the venue, then the computer executable instructions may be configured to cease playing or receiving content 305.

In some embodiments, computer executable instructions 304 may be operative to receive CGUI 308 from a server, such as a remote server. CGUI 308 may be received via a wide area network, such as the internet.

Referring now to FIG. 4, a block diagram representing a method 400 is shown in accordance with one embodiment, wherein method 400 comprises receiving audio or video content (“content”) from at least one media device positioned in at least one venue (block 402), transmitting the audio or video content to at least one mobile device (block 404), and transmitting at least one custom graphical user interface (“CGUI”) or information related to CGUI to the at least one mobile device (block 406).

In some embodiments, method 400 may be performed by a processor, which may comprise any type of processor, such as, but not limited to, a single core processor, a multi core processor, a server processor, and the like. In some embodiments, the processor may be connected to, part of, or integrated with at least one content rebroadcasting device. The content rebroadcasting device may comprise a signal processor, such as signal processor, including the various embodiments described throughout the present disclosure.

In some embodiments, method 400 may be carried out by computer executable instructions, which may comprise any type of computer executable instructions, such as a computer application, which may be encoded in any computer language. The Computer executable instructions may be stored on a transitory or non-transitory computer readable medium, such as a memory module, a hard drive, flash memory, a removable computer readable medium, and the like, wherein said computer readable medium may be connected to or in communication with the processor.

In some embodiments, the at least one media device may comprise any type of media device, including the various embodiments described throughout the present disclosure.

In some embodiments, the content may comprise any type of content, such as those embodiments described herein.

In some embodiments, the at least one venue may be any type of venue or establishment, such as those embodiments described herein.

In some embodiments, the at least one mobile device may comprise any type of mobile device, including the various embodiments described throughout the present disclosure Accordingly, in some embodiments, the mobile device may be connected to the processor via a WLAN and a WLAN access module, including the various embodiments described throughout the present disclosure.

In some embodiments, the CGUI may comprise any type of graphical user interface, such as those embodiments described throughout the present disclosure. Referring to FIG. 2B, an embodiment of a CGUI 210 is shown displayed on a display device of a mobile device, wherein CGUI 210 may comprise a theme based on the at least one venue. In some embodiments, CGUI 210 may comprise colors, graphics, images, logos, trademarks, designs, and the like associated with the venue. In other embodiment, CGUI 210 may comprise options for viewing venue's products or services, venue's specials, available content, social networking features, settings, and the like. CGUI 210 may comprise virtual buttons and entry fields.

In another embodiment, CGUI 210 may comprise information related to the content, such as available content channels, programming, scheduled times of play, time left in program, screen shots of the content (as described above), and the like.

In some embodiments, method 400 may comprise determining a location of the mobile device or receive location related information from the mobile device. Determining a location of the mobile device may comprise using the mobile device's internet protocol (IP) address to determine the location of the mobile device, using WLAN positioning techniques to determine the location of the mobile device, using a location determination device connected to or integrated with the mobile device to determine the location of the mobile device's location, determining which WLAN access module the mobile device is connected to, signal triangulation, and other location determination means and methods described throughout the present application. In some embodiments, receiving location related information from the mobile device may comprise receiving a location determined by using a location determination device connected to the mobile device, receiving an IP address, and the like. In some embodiments, method 400 may comprise determining a location of the mobile device based on the location related information.

In some embodiments, method 400 may comprise determining which venue the mobile device is located at, wherein the determination may be based on the location of the mobile device.

In another embodiment, the CGUI may be based on the location of the mobile device. Accordingly, the CGUI may be selected based on the location of mobile device. For example, if the mobile device is determined to be in Venue A (or a location associated with Venue A), then a CGUI associated with Venue A may be presented to and/or on the mobile device. If the mobile device later moves to Venue B, then a CGUI associated with Venue B may be presented and/or on the mobile device.

In some embodiments, method 400 may comprise establishing a geofencing rights management system, wherein the content may be transmitted to the mobile device only if the mobile device is located in the venue where the content is being played. Accordingly, in some embodiments, method 400 may comprise tracking the location of the mobile device and if the mobile device travels outside of the venue, then method 400 may comprise ceasing to transmit the content to the mobile device.

In some embodiments, transmitting information related to the at least one custom graphical user interface comprises a location of the mobile device, a location of the venue, a venue identifier, and the like, so that the mobile device can select which CGUI to present.

In some embodiments, method 400 may comprise receiving the CGUI from a server, such as a remote server. The CGUI may be received via a wide area network, such as the internet. The CGUI may be stored in a computer readable medium connected to the processor.

While, in some cases, the various embodiments described herein have been described in relation to use in a restaurant or bar, it should be understood that the various embodiments may also be used in other places, such as airports, offices, doctor offices, public places, hospitals, airplanes, stadiums, arenas, libraries, gyms, recreation centers, and the like. The audio broadcast may also comprise a foreign language translation.

### Hardware and Operating Environment

This section provides an overview of example hardware and the operating environments in conjunction with which embodiments of the inventive subject matter can be implemented.

A software program may be launched from a computer readable medium in a computer-based system to execute function defined in the software program. Various programming languages may be employed to create software programs designed to implement and perform the methods disclosed herein. The programs may be structured in an object-orientated format using an object-oriented language such as Java or C++. Alternatively the programs may be structured in a procedure-oriented format using a procedural language, such as assembly or C. The software components may communicate using a number of mechanisms, such as application program interfaces, or inter-process communication techniques, including remote procedure calls. The teachings of various embodiments are not limited to any particular programming language or environment. Thus, other embodiments may be realized, as discussed below.

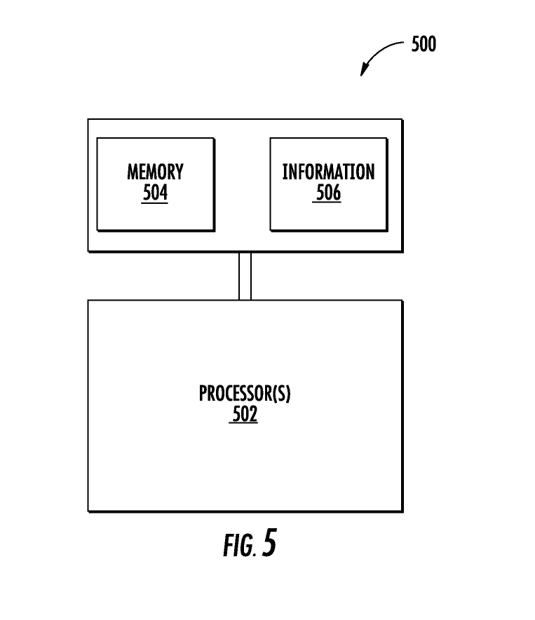

Referring to FIG. 5, a block diagram representing an article 500 comprising hardware and software may be provided in accordance with various embodiments. Such embodiments may comprise a computer, a memory system, a magnetic or optical disk, some other storage device, or any type of electronic device or system. The article may include one or more processor(s) 502 coupled to a machine-accessible medium such as a memory 504 (e.g., a memory including electrical, optical, or electromagnetic elements). The medium may contain associated information 506 (e.g., computer program instructions, data, or both) which, when accessed, results in a machine (e.g., the processor(s)) performing the activities previously described herein.

The principles of the present disclosure may be applied to all types of computers, systems, and the like, include desktop computers, servers, notebook computers, personal digital assistants, and the like. However, the present disclosure may not be limited to the personal computer.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed is:

1. A system comprising:
a. at least one processor; and
b. computer executable instructions readable by the at least one processor and configured to:
a. receive audio or video content from at least one media device positioned in at least one venue;
b. transmit the audio or video content to at least one mobile device; and
c. transmit at least one custom graphical user interface or information related to the at least one custom graphical user interface to the at least one mobile device.

2. The system of claim 1, wherein the at least one custom graphical user interface comprises a theme based on the at least one venue.

3. The system of claim 1, wherein the at least one custom graphical user interface may comprise information related to the audio or video content transmitted to the at least one mobile device.

4. The system of claim 1, wherein the computer executable instructions are configured to determine a location of the at least one mobile device or receive location related information from the at least one mobile device.

5. The system of claim 4, wherein the at least one custom graphical user interface is based on a location of the mobile device.

6. The system of claim 4, wherein the computer executable instructions are configured to transmit the audio or video content to the at least one mobile device only if the location of the at least one mobile device is inside the at least one venue.

7. The system of claim 1, wherein the at least one processor is part of at least one content rebroadcasting device positioned in the at least one venue.

8. The system of claim 1, wherein the computer executable instructions are configured to receive the at least one custom graphical user interface from at least one server.

9. A system comprising:
a. at least one processor; and
b. computer executable instructions readable by the at least one processor and configured to:
a. receive audio or video content from at least one content rebroadcasting device positioned in at least one venue;
b. receive at least one custom graphical user interface or information related to the at least one custom graphical user interface from the at least one content rebroadcasting device, or select at least one custom graphical user interface stored on a storage module connected to the at least one processor; and
c. display the at least one custom graphical user interface on a display device connected to the at least one processor.

10. The system of claim 9, wherein the at least one custom graphical user interface corresponds to the at least one venue.

11. The system of claim 9, wherein the at least one custom graphical user interface may comprise information related to the audio or video content.

12. The system of claim 9, wherein the computer executable instructions are configured to use a location determination device connected to the at least one processor to determine a location of the at least one processor or a location of the location determination device and transmit the location of the at least one processor or the location of the location determination device to the content rebroadcasting device.

13. The system of claim 9, wherein the at least one custom graphical user interface is based on a location of the at least one processor or a location of a location determination device connected to the at least one processor.

14. The system of claim 9, wherein the computer executable instructions are configured to download the custom graphical user interface and store the custom graphical user interface for future use.

15. The system of claim 9, wherein the computer executable instructions are configured to select the at least one customer graphical user interface based on:
a. a location of the at least one processor;
b. a location of a location determination device connected to the at least one processor; or
c. the at least one venue.

16. The system of claim 9, wherein the computer executable instructions are configured to use at least one audio or video broadcasting device connected to the at least one processor to broadcast the audio or video content.

17. The system of claim 9, wherein the computer executable instructions comprise a mobile application.

18. A method comprising:
a. receiving audio or video content from at least one media device positioned in at least one venue;
b. transmitting the audio or video content to at least one mobile device; and
c. transmitting at least one custom graphical user interface or information related to the at least one custom graphical user interface to the at least one mobile device.

19. The method of claim 18, wherein the at least one custom graphical user interface comprises a theme based on the at least one venue.

20. The method of claim 18, wherein the at least one custom graphical user interface is used to present information related to the audio or video content on the at least one mobile device.

21. The method of claim 18, wherein the computer executable instructions are configured to determine a location of the at least one mobile device or receive location related information from the at least one mobile device.

22. The method of claim 21, wherein the at least one custom graphical user interface is based on a location of the at least one mobile device.

23. The method of claim 21, wherein transmitting the audio or video content to the at least one mobile device comprises transmitting the audio or video content to the at least one mobile device only if the location of the at least one mobile device is inside the at least one venue.

24. The method of claim 21, wherein the computer executable instructions are configured to receive the at least one custom graphical user interface from at least one server.
